(19) United States
(12) Patent Application Publication
(10) Pub. No.: US 2013/0325963 A1
(43) Pub. Date: Dec. 5, 2013

(54) INFORMATION PROCESSING DEVICE, INFORMATION PROCESSING METHOD, AND PROGRAM

(71) Applicant: Sony Corporation, Tokyo (JP)

(72) Inventors: Hiroyuki Suzuki, Kanagawa (JP); Noboru Murabayashi, Saitama (JP)

(73) Assignee: SONY CORPORATION, Tokyo (JP)

(21) Appl. No.: 13/901,129

(22) Filed: May 23, 2013

(30) Foreign Application Priority Data
May 31, 2012 (JP) 2012-124075

(51) Int. Cl. H04L 29/06

(52) U.S. Cl. CPC H04L 65/403
USPC 709/204

(57) ABSTRACT

There is provided an information processing device including a playback processing unit for playing back media-recorded content recorded on an information recording medium, a feature extraction unit for extracting a feature amount of the media-recorded content, and an information processing unit for obtaining a comment which is set to similar content having a feature amount analogous to the feature amount of the media-recorded content extracted by the feature extraction unit and for performing control in a manner that the obtained comment is superimposed on a playback image of the media-recorded content.

### BACKGROUND

The present disclosure relates to an information processing device, an information processing method, and a program. More particularly, the present disclosure relates to an information processing device, an information processing method, and a program, for displaying a comment while content is played back.

Information communication via a network has become widespread. For example, there has been a system in which many users can view and share comments. In this system, a server on a network delivers images to users, a user who is viewing the delivered image transmits a comment to the server, and the comment is delivered along with an image to be further delivered.

In such a system, comments received from many users can be viewed simultaneously by many users who are viewing the same image, and many users can exchange information or make a discussion between each other via a network. In addition, a system for delivering comments is disclosed in, for example, JP 4799515B, and so on.

Such an information exchange technology via a network makes it possible for a user to view content more enjoyable and become a major factor for the higher value-added content. Further, information exchange between users who enjoy the same content makes it possible to obtain an extended communication range between users and create a new service that allows the activation of communication between users as well as the viewing of content.

However, such a system that shares comments added to content is intended for, e.g., live images, or the same content of the same delivery source (or, the same recording medium or the same media) placed on a network. Thus, a process for using content between different recording mediums or media in which content is recorded in a disk owned by each user, such as a DVD and BD (Blu-Ray Disc), or storage media such as a semiconductor memory has not been assumed.

In addition, a system in the related art that delivers an image along with a comment is intended for particular content to be delivered. That is, a process for providing and sharing a comment with respect to any content such as content optionally selected by a user, specifically content recorded in a disk, besides content prepared previously has not been implemented in the related art.

### SUMMARY

Embodiments of the present disclosure have been made in view of the aforementioned problems. In accordance with embodiments of the present disclosure, there is provided an information processing device, information processing method, and program, which can provide and share a comment between different recording mediums or media with respect to any content such as content optionally selected by a user, for example content recorded in a disk, besides content prepared previously.

According to a first embodiment of the present disclosure, there is provided an information processing device including a playback processing unit for playing back media-recorded content recorded on an information recording medium, a feature extraction unit for extracting a feature amount of the media-recorded content, and an information processing unit for obtaining a comment which is set to similar content having a feature amount analogous to the feature amount of the media-recorded content extracted by the feature extraction unit and for performing control in a manner that the obtained comment is superimposed on a playback image of the media-recorded content.

Further, the information processing unit may transmit the feature amount of the media-recorded content extracted by the feature extraction unit to a server. The server may retrieve similar content having a feature amount analogous to the feature amount of the media-recorded content and may transmit a comment which is set to the retrieved similar content to the information processing unit. The information processing unit may obtain the comment which is set to the similar content.

Further, when receiving an additional comment, the information processing unit may perform control in a manner that the additional comment is superimposed on the playback image of the media-recorded content along with the obtained comment.

Further, the information processing unit may perform comment output control that is capable of distinguish the obtained comment from the additional comment.

Further, the information processing unit may determine whether a position on which the obtained comment is output is overlapped on a facial region in the playback image of the media-recorded content. If determined that the position is overlapped on the facial region, the information processing unit may perform a process of changing the position on which the obtained comment is output.

Further, when receiving an additional comment, the information processing unit may perform a process of transmitting the additional comment to a server.

Further, when playing back the media-recorded content, the playback processing unit may perform playback speed control under which a playback speed of a segment to which the comment is assigned is slower than a playback speed of another segment.

According to a second embodiment of the present disclosure, there is provided a server for receiving feature amount information of playback content to be played back by a playback device, retrieving similar content having a feature amount analogous to a received feature amount, and outputting a comment which is set to the retrieved similar content to the playback device.

Further, the server may be configured to receive an additional comment input by a user from the playback device and to perform a process of recording the received additional comment as a comment corresponding to the similar content which is similar to the playback content.

Further, the server may be further configured to apply a feature amount of the content received from the playback device or information about a position at which the content is played back in a process of determining a position of the additional comment to be recorded on the similar content.

According to a third embodiment of the present disclosure, there is provided an information processing method performed in an information processing device, the method including playing back, by a playback processing unit, media-recorded content recorded on an information recording medium, extracting, by a feature extraction unit, a feature amount of the media-recorded content, obtaining, by an information processing unit, a comment which is set to similar content having a feature amount analogous to the feature amount of the media-recorded content extracted by the feature extraction unit, and performing, by the information processing unit, control in a manner that the obtained comment is superimposed on a playback image of the media-recorded content.

According to a fourth embodiment of the present disclosure, there is provided a program for causing an information process to be executed in an information processing device, the information process including playing back, by a playback processing unit, media-recorded content recorded on an information recording medium, extracting, by a feature extraction unit, a feature amount of the media-recorded content, obtaining, by an information processing unit, a comment which is set to similar content having a feature amount analogous to the feature amount of the media-recorded content extracted by the feature extraction unit, and performing, by the information processing unit, control in a manner that the obtained comment is superimposed on a playback image of the media-recorded content.

Note that the program according to the embodiment of the present disclosure is a program that can be provided in a storage medium or communication medium that is provided in a computer-readable form for an information processing device or a computer system that is capable of executing various types of program code, for example. Providing this sort of program in a computer-readable form makes it possible to implement the processing according to the program in the information processing device or the computer system.

The purposes, features, and advantages of the present disclosure will be made clear later by a more detailed explanation that is based on the embodiments of the present disclosure and the appended drawings. Furthermore, the system in this specification is not limited to being a configuration that logically aggregates a plurality of devices, all of which are contained within the same housing.

According to the embodiments of the present disclosure described above, it is possible to implement the device and method that can display a comment corresponding to similar content input from the exterior in conjunction with the playback of content obtained from media.

More specifically, the embodiments of the present disclosure include a playback processing unit for performing a playback process of media-recorded content recorded on an information recording medium such as BD; a feature extraction unit for extracting a feature amount of the media-recorded content; an information processing unit for retrieving similar content having a feature amount similar to the feature amount of the media-recorded content extracted by the feature extraction unit, obtaining a comment which is set to the retrieved similar content, and performing control such that the obtained comment is superimposed on a playback image of the media-recorded content; and a display processing unit for superimposing the obtained comment on the playback image of the media-recorded content based on the control of the information processing unit.

In accordance with the embodiments of the present disclosure described above, even when no comment is assigned to, for example, media-recorded content recorded on an information recording medium such as BD, it is possible to obtain and display a comment corresponding to the similar content and know the degree of interest and thoughts of many other users, thereby playing back and enjoying the higher value-added content.

### BRIEF DESCRIPTION OF THE DRAWINGS

FIG. 1 is a diagram for explaining an overview of a content playback process that uses an information processing device;

FIG. 2 is a diagram for explaining a process performed by the information processing device and a server;

FIG. 3 is a diagram for explaining content playback control performed by the information processing device;

FIG. 4 is a diagram for explaining an exemplary process of recording an additional comment with respect to content, which is performed by the server;

FIG. 5 is a diagram for explaining an exemplary process of recording an additional comment with respect to content, which is performed by the server;

FIG. 6 is a diagram for explaining an exemplary comment display process;

FIG. 7 is a diagram for explaining an exemplary comment display process;

FIG. 8 is a diagram for explaining an exemplary configuration of the information processing device;

FIG. 9 is a diagram illustrating a flowchart for explaining a process sequence performed by the information processing device; and

FIG. 10 is a diagram illustrating a flowchart for explaining a process sequence performed by the information processing device.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

An information processing device, information processing method, and program according to an embodiment of the present disclosure will be described below in detail with reference to the drawings. The description will be made in the following order.

1. Overview of Content Playback Process using Information Processing Device

2. Overview of Process performed by Information Processing Device and Server

3. Content Playback Control Process performed by Information Processing Device

4. Exemplary Comment Setting Process with respect to Content held in Server

5. Comment Display Control Process

6. Exemplary Configuration of Information Processing Device

7. Process Sequence performed by Information Processing Device

8. Conclusion of Configuration according to Embodiment of Present Disclosure

[1. Overview of Content Playback Process Using Information Processing Device]

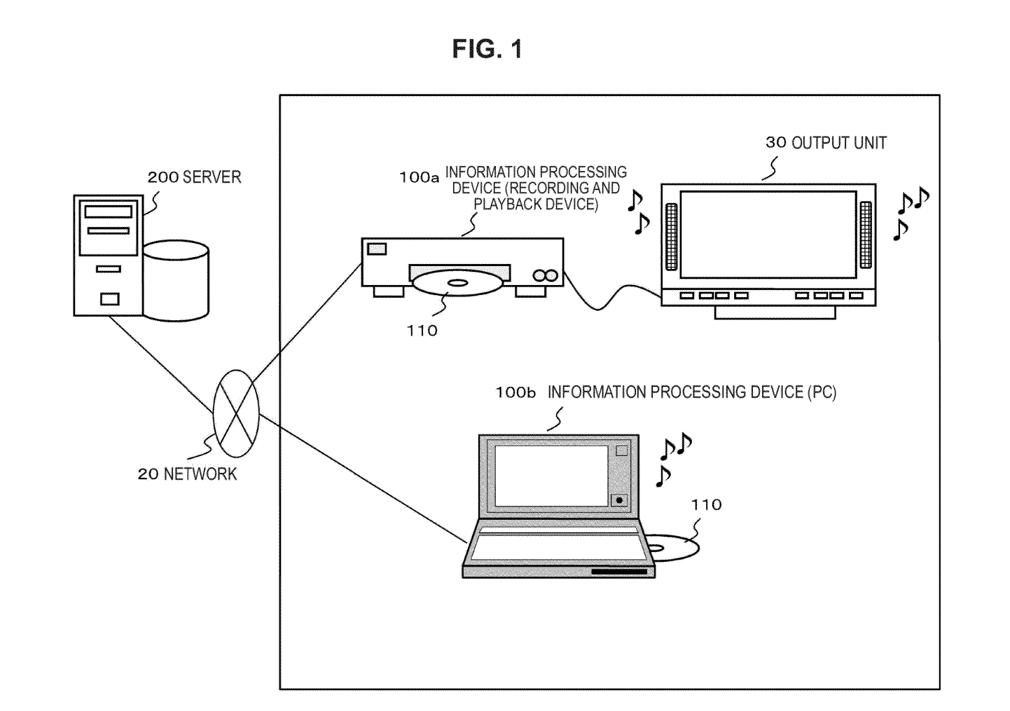

An overview of a content playback process which makes use of an information processing device according to an embodiment of the present disclosure will be described with reference to FIG. 1. The information processing device according to an embodiment of the present disclosure is a device which performs playback of content from an information recording medium, specifically various recording media such as BD (Blu-Ray Disc), DVD, or flash memory, on which the content such as images or music is recorded.

In FIG. 1, as an example of the information processing device, an information processing device 100a acting as a recording and playback device such as a BD recorder or a BD player, and an information processing device 100b acting as a PC are illustrated.

The information processing devices 100a and 100b play back content, for example, by installing an information recording medium 110 such as BD. In addition, the information recording medium 110 is recorded with, for example, content such as still images, moving images, and music. The information processing device 100a which is a playback device such as a BD recorder or a BD player is connected to an output unit 30 including a display and a speaker. Data (audio/image) which is played back from the information recording medium 110 by the information processing device 100a is output at the output unit 30. The information processing device 100b acting as a PC includes a speaker and a display. Data (audio/image) which is played back from the information recording medium 110 by the information processing device 100b is output at a speaker and a display of a PC.

In addition, the information processing device 100 is connected to a server 200 via a network 20 during playback of content obtained from the information recording medium 110. The server 200 may be a server that provides, for example, Web site, and includes various pieces of content. The server 200 includes a content database for storing various pieces of content. The content stored in the content database includes content on which a comment assigned by a user at the time of user's browsing is recorded. In addition, while only one server 200 is illustrated in FIG. 1, a plurality of servers can be connected to the network 20, and the information processing device 100 can access to a plurality of servers via the network 20.

[2. Overview of Process Performed by Information Processing Device and Server]

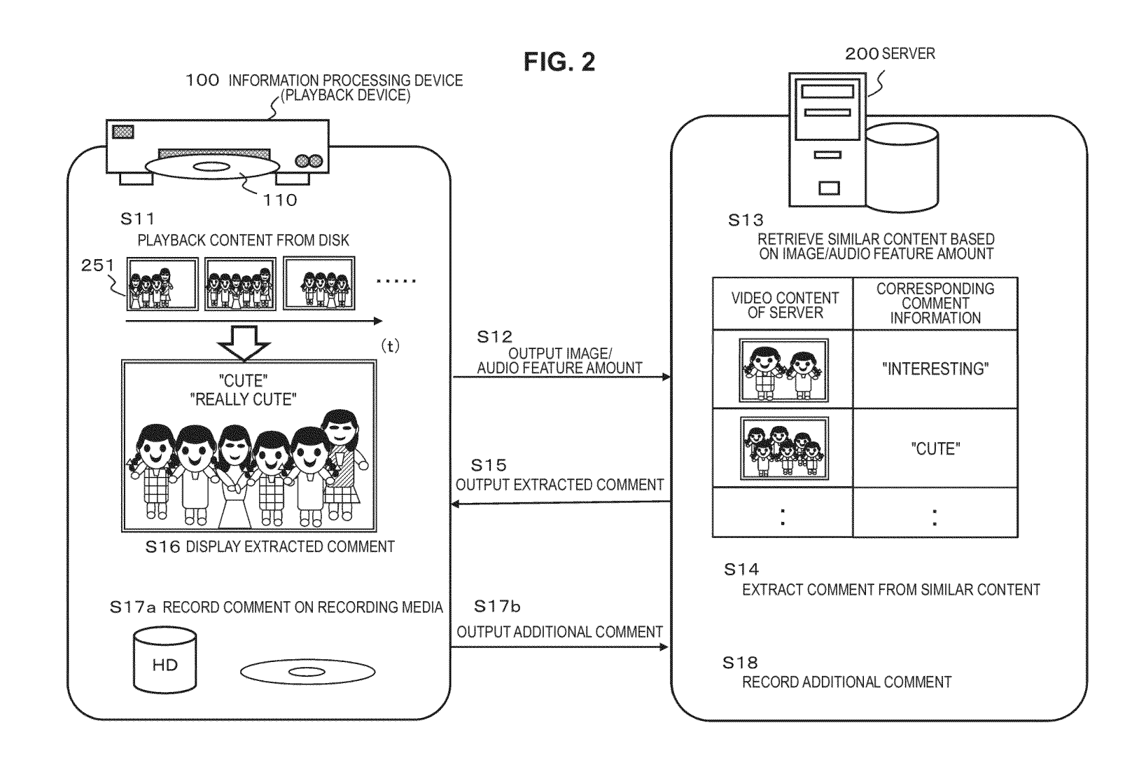

Next, an overview of the process performed by the information processing device and the server according to an embodiment of the present disclosure will be descried with reference to FIG. 2. In addition, the information processing device 100 can play back content from various recording media, such as BD, DVD, or flash memory, on which content is recorded. However, in the following description, an example will be described where the information recording medium 110 is BD (Blu-Ray Disc) on which content is recorded.

For example, the user who holds the information recording medium 110 on which content such as moving images is recorded plays back content by installing the information recording medium 110 to the information processing device 100. Each process in steps S11 to S17 shown in FIG. 2 will be described below. Step S11 is the content playback process as aforementioned.

Images 251 illustrated in FIG. 2 indicate each frame included in a moving image that is the content being played back. The information processing device 100 attempts to connect to the server 200 at the start of content playback, and then the information processing device 100 establishes a communication state with the server 200 during the period of content playback. In step S12, the information processing device 100 plays back content, and at the same time extracts a feature amount of an image frame or audio corresponding to each scene of the content being played back and transmit the extracted feature amount to the server 200.

In addition, the feature amount of content corresponding to the scene that is transmitted to the server 200 is a feature amount extracted by the information processing device 100 in units of content, or in units of each image frame or a plurality of frames of content. Alternatively, the feature amount of content may be a feature amount recorded on a disk (information recording medium 110) as attribute information.

In step S13, the server 200 receives the feature amount of content from the information processing device 100, and retrieves similar content having a feature amount analogous to the received feature amount of content from a plurality of pieces content stored in the content database based on the feature amount of content received from the information processing device 100. In addition, for example, when content is a moving image, the extraction of similar content is performed in units of scenes included in content of the moving image, for example, in units of image frames. When content is a still image, the extraction of similar content is performed in units of still images. The retrieval of content performed by the server 200 is also intended for still images besides video streams included in content of the moving image.

Furthermore, in step S14, the server 200 extracts a comment that is set previously with respect to the similar content obtained as a retrieval result. This preset comment is a comment that is set by various users who viewed the content or similar content analogous to the content.

Moreover, the content retrieval process performed in the server 200 is to extract a comment of the user from content similar to the content being played back. Thus, for example, when a plurality of pieces content are present in the content database, it may be possible to configure to perform the content retrieval in which a set of content having a large amount of the preset comment information is intended to be retrieved. Alternatively, it may be possible to perform the process in which the content with a good image quality is preferentially retrieved.

In addition, the determination of the amount of comment information can be performed by measuring the number of characters assigned to a screen. The detection of information in a screen can be performed using the telop detection technique. For example, the technique disclosed in Japanese Patent Application Laid-Open No. 2007-329832, entitled “IMAGE PROCESSING APPARATUS AND METHOD, DETECTION DEVICE AND METHOD, PROGRAM AND RECORDING MEDIUM” can be applied to the detection of information.

In step S15, the server 200 outputs the extracted comment to the information processing device 100. In step S16, the information processing device 100 displays the comment received from the server 200 along with the content being played back. As shown in step S16 of FIG. 2, for example, the comment “cute” displayed on a screen of the information processing device 100 corresponds to the comment extracted from the similar content by the server 200.

The user can assign a new comment in response to the information based on the displayed comment. As shown in step S16 of FIG. 2, for example, the comment “really cute” displayed on a screen of the information processing device 100 is an additional comment.

Furthermore, in step S17a, the information processing device 100 records information about the additional comment on a hard disk of the information processing device 100, the information recording medium 110 which is content playback media, or the like. In addition, in step S17b, the information processing device 100 transmits the additional comment to the server 200. In step S18, the server 200 additionally records the additional comment received from the information processing device as a comment corresponding to the content from which the comment has been extracted.

[3. Content Playback Control Process Performed by Information Processing Device]

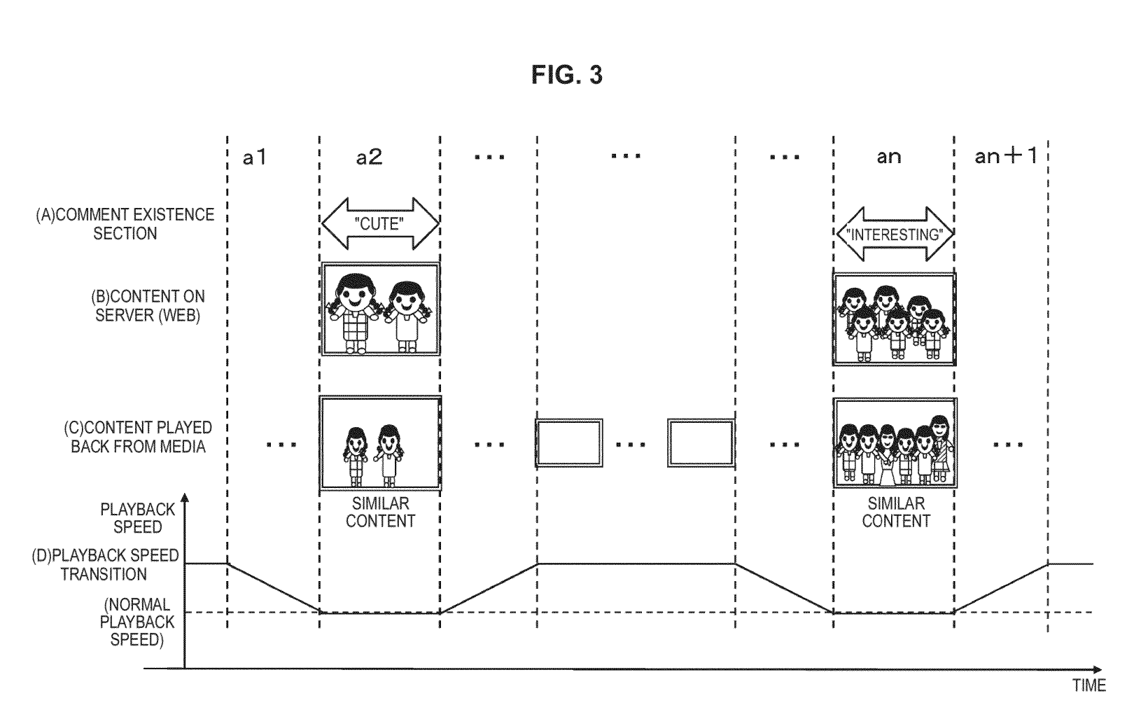

Next, an exemplary content playback control process performed by the information processing device which plays back content will be described with reference to FIG. 3.

For example, most of sections of a comment that is set to image content can be assumed to be sections in which the user is interested, and they can be estimated to be content sections in which the user is likely to view and be interested in, namely noticed content sections having a high degree of user's attention.

An example of the content playback control process that performs digest playback for the noticed content section to which a comment is assigned will be described below with reference to FIG. 3. In FIG. 3, the horizontal axis indicates the time axis (t) as the playback time of content, and the scenes (image frame) of the content being played back and a comment that is set for each scene are indicated at each time. In FIG. 3, time-series data of the following data is indicated.

(A) Comment existence section

(B) Content on a server (similar content)

(C) Content being played back from media

(D) Playback speed transition (when the digest playback or retrieval mode is performed)

The playback sections a2, a5 are playback sections in which a comment is existed. A playback processing unit of the information processing device controls a playback speed according to the (D) playback speed transition shown in FIG. 3 when the digest playback or retrieval mode is performed. In other words, the playback speed of the playback sections a2, a5 that are comment-setting sections is set to be a normal playback speed, and the playback speed of the rest playback sections is set to be a high-speed playback process.

In addition, in the example shown in FIG. 3, the playback speed of the front and rear sections of the comment-setting sections a2, a5 is gradually changed. If only the comment setting sections a2, a5 are set to be a normal speed, only the corresponding scene is played back, and thus it becomes difficult to understand the context of the details of content. Therefore, the gradual change in the playback speed is intended to prevent the details of the content being played back from being difficult to understand.

In an image frame to which a comment is set, when setting a comment, identification information (metadata) indicating a comment setting frame is set. The playback processing unit of the information processing device controls the playback speed with reference to this metadata.

[4. Exemplary Comment Setting Process with Respect to Content Held in Server]

As described above, the information processing device 100 shown in FIGS. 1 and 2 transmits a feature amount of the content being played back of the information recording medium 110 such as BD installed to the information processing device 100 to the server 200. The server 200 retrieves similar content or scene from content held by the server based on the received feature amount. The server 200 then extracts a comment which is set to the similar content or scene obtained as the retrieval result and transmits the extracted comment to the information processing device 100. The information processing device 100 displays the comment along with the content which is being displayed and played back on the information processing device 100 or a display unit connected to the information processing device 100.

The user who is viewing the content being played back can further input an additional comment. This additional comment can be superimposed on the content in which the user views, and, as described in the process of steps S17 to S18 of FIG. 2, the additional comment also can be transmitted to the server side and is additionally recorded as a comment corresponding to the content held by the server.

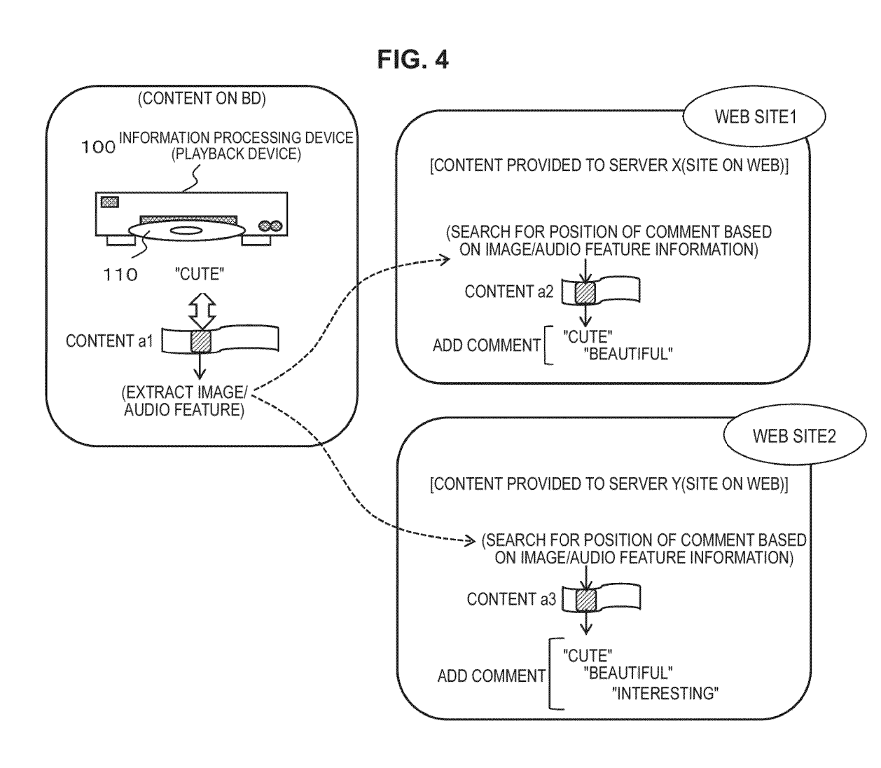

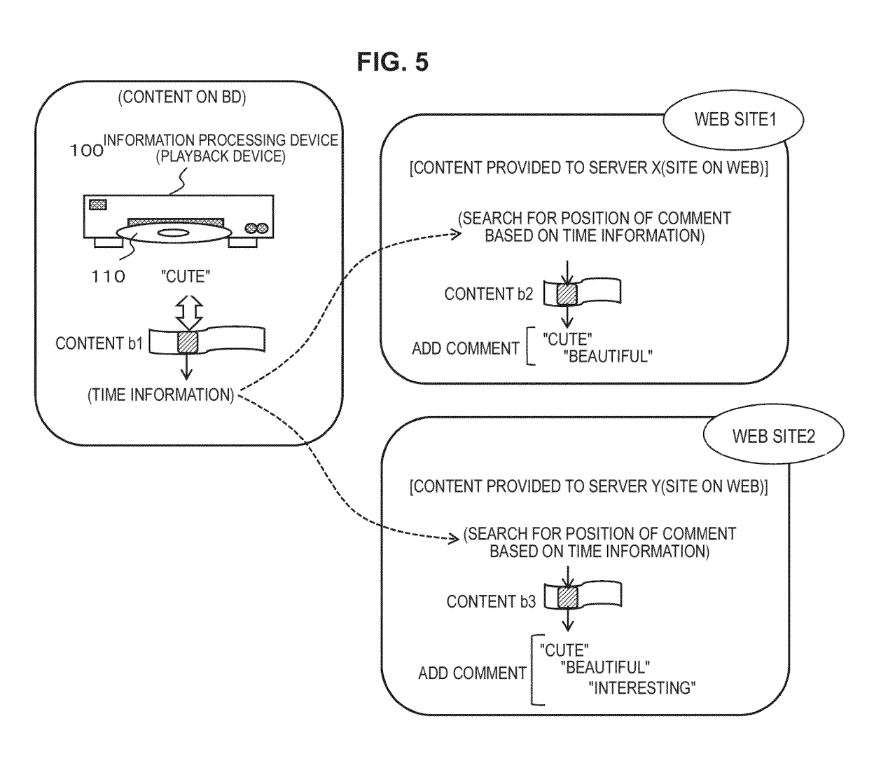

How to determine the position on which a comment is recorded when the comment addition recording process is performed in the server will be described by using two exemplary processes with reference to FIGS. 4 and 5. FIG. 4 illustrates the case where the comment setting position is determined based on an image/audio feature amount. The information processing device 100 shown in FIG. 4 plays back a content a1 that is content stored in the information recording medium 110 such as BD installed to the information processing device 100.

The user inputs an additional comment with respect to the content a1 being played back. The additional comment is superimposed on the content in which the user views. Furthermore, as described in the process of steps S17 to S18 of FIG. 2, the additional comment is transmitted to the server. When this process is performed, information that is transmitted from the information processing device to the server side is relevant to an image/audio feature amount with respect to a scene that a comment is added.

In an example shown in FIG. 4, two servers are illustrated, namely a server X which provides a Web site 1 and a server Y which provides a Web site 2. The information processing device 100 extracts a feature amount of the content a1 being played back and transmits it to the servers X and Y. Each of the servers retrieves similar content or scene from among the content held by the servers based on the received feature amount information. Each of the servers then records an additional comment of the user transmitted from the information processing device 100 on the content database in association with image frames as a comment with respect to the similar content or scene obtained as a retrieval result.

FIG. 5 is a diagram for explaining an exemplary process in which time information is used without using information relevant to an image/audio feature amount when the comment addition recording process in the server is performed. The comment addition recording process that uses this time information can be applied to the case where the server holds the same content as a content b1 that is content stored in the information recording medium 110 such as BD installed to the information processing device 100.

If different recording mediums or media are assumed to have the same content, the content of each of the servers X and Y, i.e., the content on the Web and the content of a disk which is being played back by the user, i.e., the information recording medium 110, have different time references. Thus, it may be considered a case where the comment assignment may be not processed at an appropriate position. Accordingly, the server calculates a relative position from a start position of content to determine a comment position. Playback time information from the content start position can be used as the relative position. Furthermore, the number of frames from the content start position may be used besides the playback time information.

In addition, the user's additional comment and the comment setting position information that explained with reference to FIGS. 4 and 5 may be configured to be recorded on not only the server but also a local storage (a memory) of the information processing device 100 of the user side, in association with content identification information.

By performing the process for recording such a comment and the comment position information, when the same content corresponding to the content identification information is then played back, the comment recorded on the local storage (a memory) can be displayed by reading out it from the same scene as the recording of the additional comment.

[5. Comment Display Control Process]

Next, an example of displaying a comment on the information processing device 100 or a display unit connected to the information processing device 100 (e.g., the output unit 30 shown in FIG. 1) of the user side will be described.

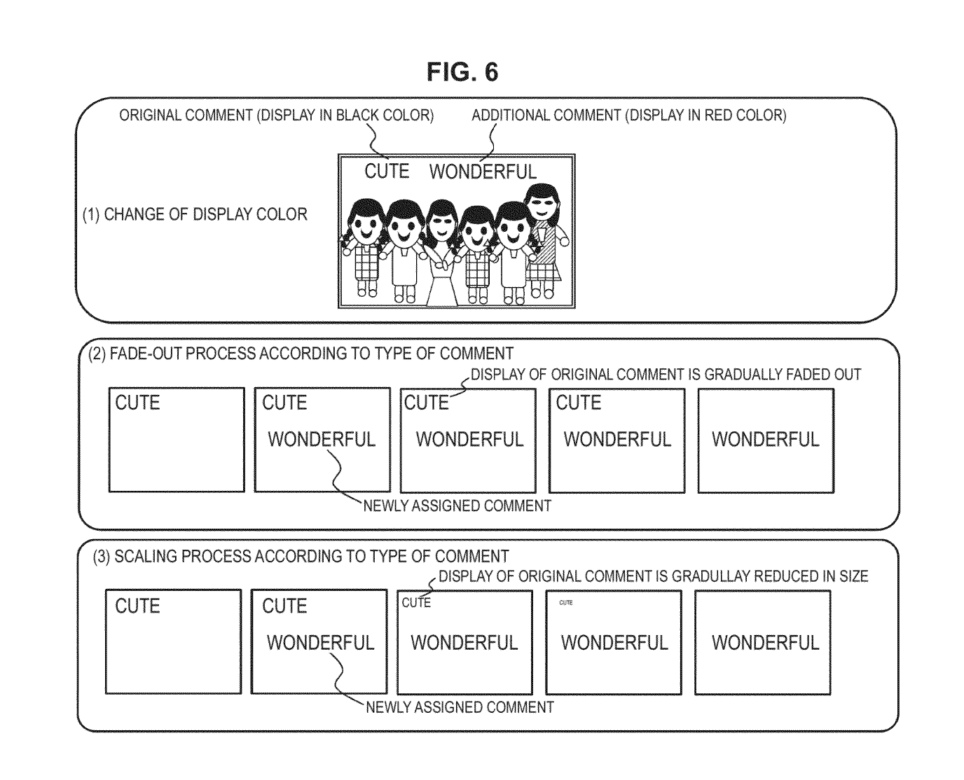

FIG. 6 illustrates an example of a screen display. In FIG. 6, three exemplary comment display processes are shown as follows:

(1) Exemplary process of displaying a comment by changing a displaying color according to the type of comment,

(2) Exemplary process of displaying a comment by fading out one of comments according to the type of comment, and

(3) Exemplary process of displaying a comment by performing a scaling process (a process of changing in size of a comment display) according to the type of comment.

FIG. 6(1)is the exemplary process of displaying a comment by changing a displaying color according to the type of comment. For example, this example indicates the process of displaying a comment by changing a color of the original comment, i.e., the comment obtained from the server and a displaying color of an additional comment that is newly added by the user. More specifically, for example, the comment obtained from the server is displayed in a black color and the additional comment that is newly added by the user is displayed in a red color.

FIG. 6(2)is the exemplary process of displaying a comment by fading out one of comments display according to the type of comment. More specifically, a comment obtained from the server may be displayed by performing the fade-out process in which display of the comment is gradually faded out.

FIG. 6(3)is the exemplary process of displaying a comment by performing a scaling process according to the type of comment. More specifically, for example, a comment obtained from the server may be displayed by performing a reduction process in which a character is gradually reduced in size.

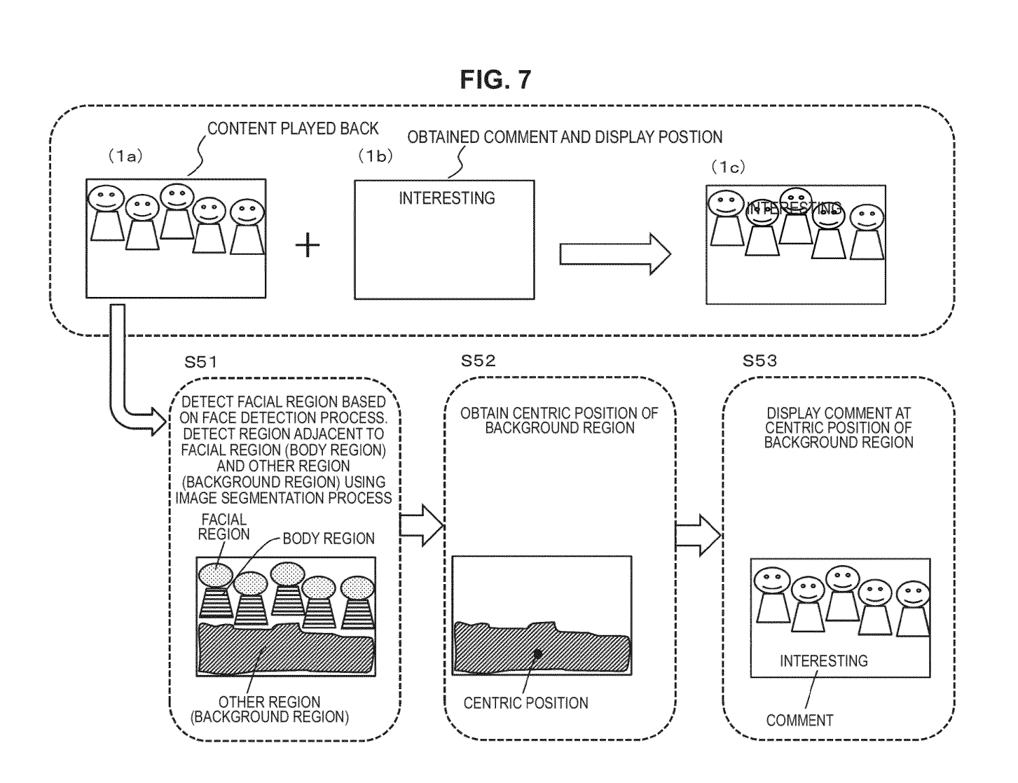

FIG. 7 is a diagram for explaining a process of determining a display position of a comment in an image. The display position of a comment is preferably set to a position that does not interfere with an image. For example, if an object such as a person's face is present on the screen, it is undesirable that a comment is displayed on the position of the face.

For example, a comment corresponding to the similar content obtained from the server is superimposed on the content being played back in the information processing device of the user side. In this case, even if the comment in the similar content that has been originally acquired is not overlapped on the face, there may be cases where a comment of the content being played back at the user side is overlapped on the face.

Therefore, when the information processing device 100 displays the comment corresponding to the similar content obtained from the server as the comment display control process, the information processing device 100 performs the following processes:

(S1) It is determined whether there is a face image in a frame on which a comment of the content being played back in the information recording medium 110 of the user side is expected to be displayed,

(S2) When it is determined that there is no face image in the frame on which the comment is expected to be displayed, the comment on the same position as the comment display position which has been displayed in the similar content from which the comment has been acquired is displayed, and

(S3) When it is determined that there is a face image in the frame on which the comment is expected to be displayed, the comment display position which has been displayed in the similar content from which the comment has been acquired is changed.

A specific example of the process for changing the comment display position of the above process (S3) will be described with reference to FIG. 7. The example shown as drawings (1a), (1b), and (1c) in the upper portion of FIG. 7 illustrates the display in which the comment display position is not adjusted. Each of the drawings indicates data as follows:

(1a) Content being played back from the information recording medium 110,

(1b) Comment corresponding to the similar content obtained from the server (Web), and

(1c) Example where a comment is superimposed without performing the adjustment of a position at which a comment is displayed.

If a comment is displayed in such a way, it will be undesirable that a comment is displayed on the position of faces as shown in FIG. 7(1c). In order to prevent such a situation from occurring, the information processing device 100 controls a position at which a comment is displayed.

Specifically, a process of each step S51 to S53 shown in FIG. 7 is performed. In step S51, the information processing device 100 analyzes an image on which the comment of the content being played back from the information recording medium 110 is expected to be displayed.

More specifically, a facial region is detected based on a face detection process, and a region adjacent to the facial region (a body region) and the other region (a background region) are detected by an image segmentation process. The image segmentation process can be performed based on a clustering process by using image feature amount data such as color data or luminance data for each pixel in the image.

Next, in step S52, a centric position of the background region is calculated. Finally, in step S53, a comment is displayed at the centric position of the background region.

By performing these processes, as shown in step S53 of FIG. 7, a comment obtained from the server can be displayed on the background region that is not superimposed on the facial region.

[6. Exemplary Configuration of Information Processing Device]

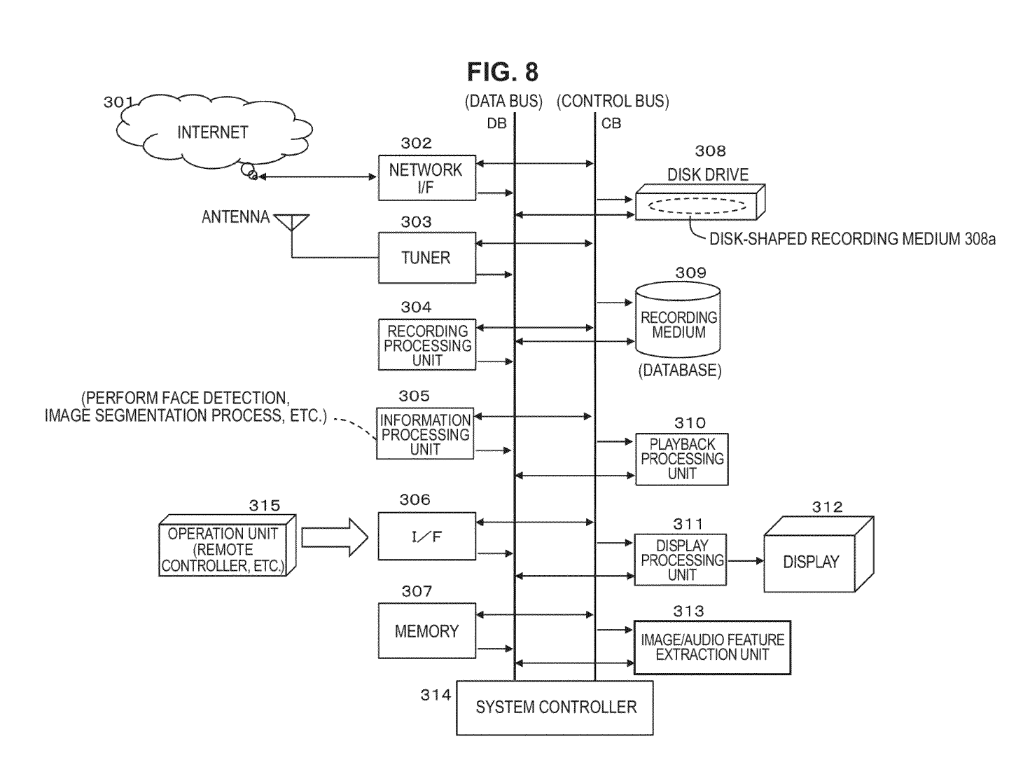

An exemplary configuration of the information processing device 100 will be described with reference to FIG. 8. The information processing device 100 including various processing systems connected to a data bus (DB) and a control bus (CB).

Specifically, the information processing device 100 includes a network I/F 302, a tuner 303, a recording processing unit 304, an information processing unit 305, an interface (I/F) 306, and a memory 307. The network I/F 302 is adapted to transmit and receive data through a network 301. The tuner 303 transmits and receives content through an antenna. The recording processing unit 304 records data on a disk-shaped recording medium 308a or a recording medium 309. The information processing unit 305 performs the process such as content retrieval, display control, face detection, and image segmentation. The interface (I/F) 306 receives input information through an operation unit such as a remote controller which is operated by a user. The memory 307 is configured to include a RAM, a ROM, or the like which is used as a temporary storage region of a comment, or processing programs or parameters to be executed by a system controller 314.

Furthermore, the information processing device 100 also includes a disk drive 308, the recording medium 309, a playback processing unit 310, a display processing unit 311, an image/audio feature extraction unit 313, and the system controller 314. The disk drive 308 is driven by inserting the disk-shaped recording medium 308a and performs a data recording and playback process. The recording medium 309 may be a hard disk or the like. The playback processing unit 310 performs a content playback control. The display processing unit 311 performs display of content or a comment on a display 312 which acts as a display unit. The image/audio feature extraction unit 313 extracts feature of images or audio of the content being played back. The system controller 314 is configured to include a CPU or the like having, for example, a program execution function which executes a centralized control of each processing unit.

In addition, when content is played back, the image/audio feature extraction unit 313 extracts an image/audio feature amount. Examples of an image feature amount include a global image feature amount such as a color feature, a luminance feature, or a texture and a local image feature amount such as the Harris corner detection or SIFT (Scale-Invariant Feature Transform).

The extracted feature amount is transmitted to a server through the network I/F 302 under the control of the information processing unit 305. The server then detects a similar scene for the extracted feature amount. The server then obtains a comment from a similar image scene of the content assigned with the comment and provides the comment to the information processing device 100. In this way, the information processing unit 305 retrieves similar content having a feature amount analogous to the feature amount extracted by the image/audio feature extraction unit 313, obtains a comment that is set to the retrieved similar content, and performs control such that the obtained comment is superimposed on the image being played back of the content recorded on a media.

In addition, the comment obtaining process executed by the information processing unit 305 is performed, for example, as the process for transmitting the feature amount extracted by the image/audio feature extraction unit 313 to the server and for obtaining a comment which is set to the similar content from the server. Furthermore, the information processing unit 305, when receiving an additional comment which is newly input by the user, causes the additional comment to be superimposed on the image being played back of the content recorded on a media along with the obtained comment and transmits the additional comment to the server. Moreover, the information processing unit 305, when controlling display of a comment, performs the comment output control for distinguishing the additional comment from the obtained comment, which has been explained with reference to FIGS. 6 and 7, or performs a process for changing a output position of the comment.

[7. Process Sequence Performed by Information Processing Device]

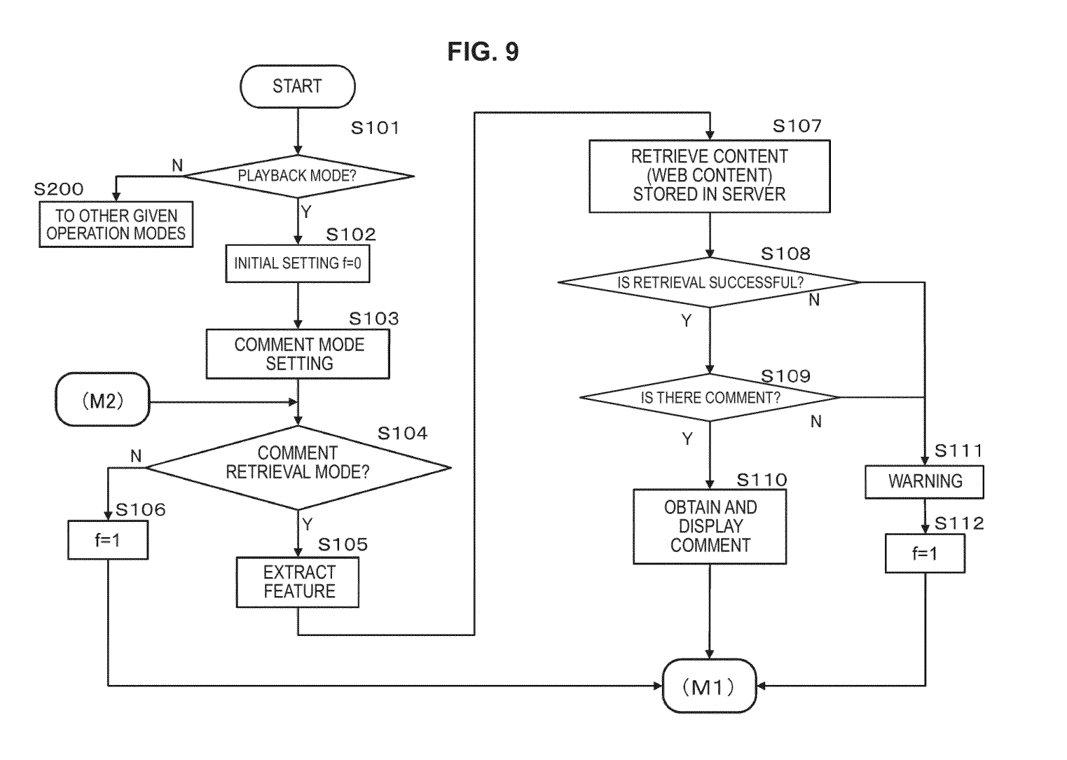

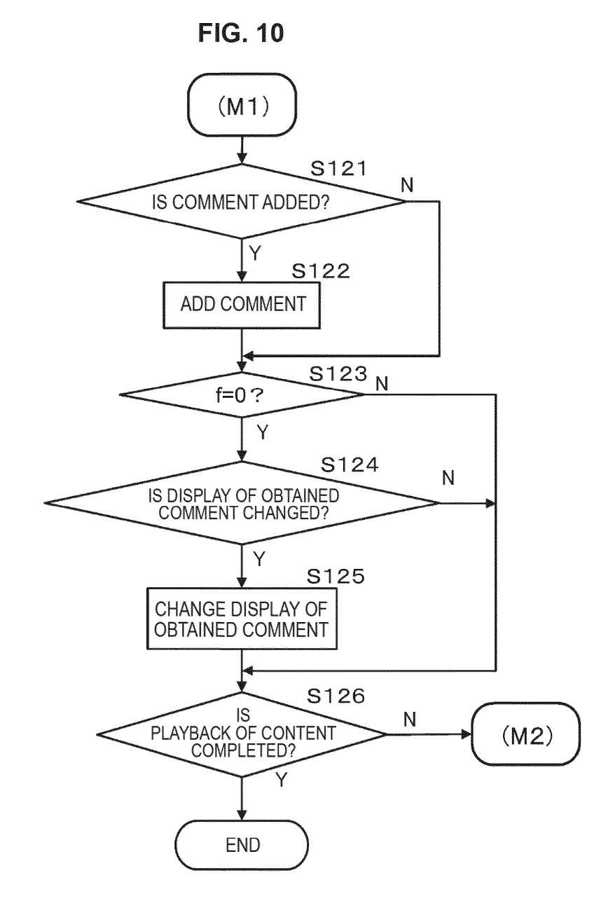

Next, a process sequence performed by the information processing device will be described with reference to flowcharts shown in FIGS. 9 and 10.

The process according to each flowchart shown in FIGS. 9 and 10 is performed by executing programs by a CPU of the system controller 314, for example, according to the programs stored in the memory 307 shown in FIG. 8.

In step S101, it is determined whether the information processing device is set to a playback mode. If it is determined that the information processing device is in the playback mode, then the flow proceeds to step S102. If it is determined that the information processing device is not in the playback mode, then the flow proceeds to step S200 and a process according to other modes is performed.

If it is determined that the information processing device is in the playback mode, then the flow proceeds to step S102 and an initial setting of a setting flag in a comment retrieval mode is performed. The setting flag in the comment retrieval mode is set to as follows.

F=1→OFF: Not execute comment retrieval

F=0→ON: Execute comment retrieval

In step S102, the initial setting of the setting flag in the comment retrieval mode is a process that is set to as follows.

F=0→ON: Execute comment retrieval

In step S103, a mode setting of a comment retrieval mode that is desired by a user is performed. This mode setting is any one of the settings “Not execute comment retrieval” and “Execute comment retrieval”, and the user input that is used to request these settings is caused to be executed through an UI (user interface).

Next, in step S104, it is determined whether the user is set to the “Execute comment retrieval” (f=0). If it is determined that the user is set to the “Execute comment retrieval”, then the flow proceeds to step S105. If it is determined that the user is set to the “Not execute comment retrieval”, the flow proceeds to step S106 and then the flow proceeds to a process (M1) by setting the flag to f=1. The process (M1) is a process to be performed according to the flowchart shown in FIG. 10 and will be described later.

In step S104, if it is determined that the user is set to the “Execute comment retrieval” (f=0), then the flow proceeds to step S105. In step S105, a feature is extracted from the content being played back. For example, a global image feature amount such as a color feature and a texture, or a local image feature amount such as the Harris corner detection and SIFT (Scale-Invariant Feature Transform) is extracted as an image feature amount. Temporal transition information such as a tone interval and a sound volume or the power spectrum for each predetermined interval (from tens of milliseconds to hundreds of milliseconds) is obtained as an audio feature amount.

Next, in step S107, content stored in the server, i.e., similar content of Web site is retrieved based on the extracted feature information. This content retrieval may be, for example, a scene retrieval process of content having a feature amount analogous to the feature amount extracted in step S105.

In step S108, it is determined whether the retrieval of similar content is successful. If it is determined that no similar content is retrieved, then the flow proceeds to step S111. In step S111, a message indicating that no comment has been obtained is displayed on a display representing the content that is being viewed by the user. Subsequently, in step S112, the flow proceeds to the process (M1) by setting the flag to f=1, i.e., “Not execute comment retrieval”. The process (M1) is a process to be performed according to the flowchart shown in FIG. 10 and will be described later.

On the other hand, in step S108, if it is determined that the retrieval of similar content is successful, the flow proceeds to step S109. In step S109, it is determined whether a comment is set to the similar content. If no comment is obtained from the similar content, then the flow proceeds to step S111. In step S111, for example, a message indicating that no comment has been obtained is displayed on a display representing the content that is being viewed by the user. Subsequently, in step S112, the flow proceeds to the process (M1) by setting the flag to f=1, i.e., “Not execute comment retrieval”. The process (M1) is a process to be performed according to the flow shown in FIG. 10 and will be described later.

In step S109, if it is determined that a comment is set to the similar content, then the flow proceeds to step S110. In step S110, a comment is obtained, and the obtained comment is displayed along with the content being played back. In addition, when this comment display is performed, it is preferable to perform the comment display position control that has been explained above with reference to FIG. 7. Subsequently, the flow proceeds to the process (M1).

Next, the process (M1) will be described with reference to the flowchart shown in FIG. 10. In step S121, it is determined that a setting for the comment addition process is valid. If it is determined that the setting is not valid, then the flow proceeds to step S123. If it is determined that the setting is valid, then the flow proceeds to step S122. In step S122, if it is checked that the user adds a comment, then the flow proceeds to S123. In addition, even in the case where it is determined that the setting is valid, if the addition of comment is not performed in a preset time period, then the flow may proceed to step S123.

In step S123, it is checked which type of setting is made for the comment retrieval mode. If it is checked that the setting “Execute comment retrieval” (f=0) is used, the flow proceeds to step S124. If it is checked that the setting “Not execute comment retrieval” (f=1) is used, the flow proceeds to step S126.

In step S124, it is determined whether a mode of changing display of the obtained comment is set. This is the process for determining whether the mode of performing the processes (1)to (3)that have been explained above with reference to FIG. 6 is set. In other words, this is the process for determining whether the mode of performing the process that can distinguish between the comment obtained from the server and an additional comment newly added from the user is set.

If it is determined that this mode is not set, then the flow proceeds to step S126. If it is determined that this mode is set, then the flow proceeds to step S125. In step S125, the display control according to a change process of the display manner according to the mode being set is performed, for example, the display control according to any one of the processes (1)to (3)of FIG. 6 is performed. When this process is completed, the flow proceeds to step S126.

In step S126, it is determined whether playback of content is completed. If it is determined that playback of content is completed, then the entire process is terminated. If it is determined that playback of content is not yet completed but is being continued, then the flow is returned to the step S104 shown in the flowchart of FIG. 9, i.e. a process (M2), and the processes of the step S104 and subsequent steps are repeatedly performed.

In accordance with the process of the embodiments of the present disclosure, for example, the following advantages can be expected. The user can easily retrieve and view content in which the user has not watched yet but it sounds interesting. In addition, the user can select only some sections of the content in which the user are interested and view the sections efficiently in a short time period. Additionally, the user can know how other viewers have felt about the content that the user wants to view. For example, such advantages can be achieved.

[8. Conclusion of Configuration According to Embodiments of Present Disclosure]

Embodiments of the present disclosure have been described in detail above with reference to particular embodiments. However, it is apparent that those skilled in the art can modify and substitute the embodiments without departing from the spirit of the embodiments of the present disclosure. That is, the embodiments of the present disclosure have been disclosed in the form of exemplification and should not be interpreted in a limited manner. The substance of the present disclosure should be judged according to the embodiments of the present disclosure.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing device including:

a playback processing unit for playing back media-recorded content recorded on an information recording medium;

a feature extraction unit for extracting a feature amount of the media-recorded content; and

an information processing unit for obtaining a comment which is set to similar content having a feature amount analogous to the feature amount of the media-recorded content extracted by the feature extraction unit and for performing control in a manner that the obtained comment is superimposed on a playback image of the media-recorded content.

(2) The information processing device according to (1),

wherein the information processing unit transmits the feature amount of the media-recorded content extracted by the feature extraction unit to a server,

wherein the server retrieves similar content having a feature amount analogous to the feature amount of the media-recorded content and transmits a comment which is set to the retrieved similar content to the information processing unit, and

wherein the information processing unit obtains the comment which is set to the similar content.

(3) The information processing device according to (1) or (2), wherein, when receiving an additional comment, the information processing unit performs control in a manner that the additional comment is superimposed on the playback image of the media-recorded content along with the obtained comment.

(4) The information processing device according to (3), wherein the information processing unit performs comment output control that is capable of distinguish the obtained comment from the additional comment.

(5) The information processing device according to any one of (1) to (4), wherein the information processing unit determines whether a position on which the obtained comment is output is overlapped on a facial region in the playback image of the media-recorded content, and

wherein, if determined that the position is overlapped on the facial region, the information processing unit performs a process of changing the position on which the obtained comment is output.

(6) The information processing device according to any one of (1) to (5), wherein, when receiving an additional comment, the information processing unit performs a process of transmitting the additional comment to a server.

(7) The information processing device according to any one of (1) to (6), wherein, when playing back the media-recorded content, the playback processing unit performs playback speed control under which a playback speed of a segment to which the comment is assigned is slower than a playback speed of another segment.

(8) A server for receiving feature amount information of playback content to be played back by a playback device, retrieving similar content having a feature amount analogous to a received feature amount, and outputting a comment which is set to the retrieved similar content to the playback device.

(9) The server according to (8), wherein the server is configured to receive an additional comment input by a user from the playback device and to perform a process of recording the received additional comment as a comment corresponding to the similar content which is similar to the playback content.

(10) The server according to (9), wherein the server is further configured to apply a feature amount of the content received from the playback device or information about a position at which the content is played back in a process of determining a position of the additional comment to be recorded on the similar content.

Further, a method of a process executed in the aforementioned apparatus or system, and a program for executing a process are all included in the configuration of the present disclosure.

Furthermore, the processing sequence that is explained in the specification can be implemented by hardware, by software and by a configuration that combines hardware and software. In a case where the processing is implemented by software, it is possible to install in memory within a computer that is incorporated into dedicated hardware a program in which the processing sequence is encoded and to execute the program. It is also possible to install a program in a general-purpose computer that is capable of performing various types of processing and to execute the program. For example, the program can be installed in advance in a storage medium. In addition to being installed in a computer from the storage medium, the program can also be received through a network, such as a local area network (LAN) or the Internet, and can be installed in a storage medium such as a hard disk or the like that is built into the computer.

Note that the various types of processing that are described in this specification may not only be performed in a temporal sequence as has been described, but may also be performed in parallel or individually, in accordance with the processing capacity of the device that performs the processing or as necessary. Furthermore, the system in this specification is not limited to being a configuration that logically aggregates a plurality of devices, all of which are contained within the same housing.

As described above, according to the embodiments of the present disclosure, it is possible to implement the device and method that can display a comment corresponding to similar content input from the exterior in conjunction with the playback of content obtained from media.

More specifically, the embodiments of the present disclosure include a playback processing unit for performing a playback process of media-recorded content recorded on an information recording medium such as BD; a feature extraction unit for extracting a feature amount of the media-recorded content; an information processing unit for retrieving similar content having a feature amount similar to the feature amount of the media-recorded content extracted by the feature extraction unit, obtaining a comment which is set to the retrieved similar content, and causing the obtained comment to be displayed in an overlapped manner on a playback image of the media-recorded content; and a display processing unit for displaying the obtained comment in an overlapped manner on the playback image of the media-recorded content based on the control of the information processing unit.

In accordance with the embodiments of the present disclosure described above, even when no comment is assigned to, for example, media-recorded content recorded on an information recording medium such as BD, it is possible to obtain and display a comment corresponding to the similar content and know the degree of interest and thoughts of many other users, thereby playing back and enjoying the higher value-added content.

The present disclosure contains subject matter related to that disclosed in Japanese Priority Patent Application JP 2012-124075 filed in the Japan Patent Office on May 31, 2012, the entire content of which is hereby incorporated by reference.

What is claimed is:

1. An information processing device comprising:
a playback processing unit for playing back media-recorded content recorded on an information recording medium;
a feature extraction unit for extracting a feature amount of the media-recorded content; and
an information processing unit for obtaining a comment which is set to similar content having a feature amount analogous to the feature amount of the media-recorded content extracted by the feature extraction unit and for performing control in a manner that the obtained comment is superimposed on a playback image of the media-recorded content.

2. The information processing device according to claim 1,
wherein the information processing unit transmits the feature amount of the media-recorded content extracted by the feature extraction unit to a server,
wherein the server retrieves similar content having a feature amount analogous to the feature amount of the media-recorded content and transmits a comment which is set to the retrieved similar content to the information processing unit, and
wherein the information processing unit obtains the comment which is set to the similar content.

3. The information processing device according to claim 1, wherein, when receiving an additional comment, the information processing unit performs control in a manner that the additional comment is superimposed on the playback image of the media-recorded content along with the obtained comment.

4. The information processing device according to claim 3, wherein the information processing unit performs comment output control that is capable of distinguish the obtained comment from the additional comment.

5. The information processing device according to claim 1, wherein the information processing unit determines whether a position on which the obtained comment is output is overlapped on a facial region in the playback image of the media-recorded content, and
wherein, if determined that the position is overlapped on the facial region, the information processing unit performs a process of changing the position on which the obtained comment is output.

6. The information processing device according to claim 1, wherein, when receiving an additional comment, the information processing unit performs a process of transmitting the additional comment to a server.

7. The information processing device according to claim 1, wherein, when playing back the media-recorded content, the playback processing unit performs playback speed control under which a playback speed of a segment to which the comment is assigned is slower than a playback speed of another segment.

8. A server for receiving feature amount information of playback content to be played back by a playback device, retrieving similar content having a feature amount analogous to a received feature amount, and outputting a comment which is set to the retrieved similar content to the playback device.

9. The server according to claim 8, wherein the server is configured to receive an additional comment input by a user from the playback device and to perform a process of recording the received additional comment as a comment corresponding to the similar content which is similar to the playback content.

10. The server according to claim 9, wherein the server is further configured to apply a feature amount of the content received from the playback device or information about a position at which the content is played back in a process of determining a position of the additional comment to be recorded on the similar content.

11. An information processing method performed in an information processing device, the method comprising:
playing back, by a playback processing unit, media-recorded content recorded on an information recording medium;
extracting, by a feature extraction unit, a feature amount of the media-recorded content;
obtaining, by an information processing unit, a comment which is set to similar content having a feature amount analogous to the feature amount of the media-recorded content extracted by the feature extraction unit; and
performing, by the information processing unit, control in a manner that the obtained comment is superimposed on a playback image of the media-recorded content.

12. A program for causing an information process to be executed in an information processing device, the information process comprising:
playing back, by a playback processing unit, media-recorded content recorded on an information recording medium;
extracting, by a feature extraction unit, a feature amount of the media-recorded content;
obtaining, by an information processing unit, a comment which is set to similar content having a feature amount analogous to the feature amount of the media-recorded content extracted by the feature extraction unit; and
performing, by the information processing unit, control in a manner that the obtained comment is superimposed on a playback image of the media-recorded content.
